(19) United States
(12) Patent Application Publication
(10) Pub. No.: US 2021/0087425 A1
(43) Pub. Date: Mar. 25, 2021

(54) AQUEOUS COATING COMPOSITION

(71) Applicants: Dow Global Technologies LLC, Midland, MI (US); Rohm and Haas Company, Collegeville, PA (US)

(72) Inventors: Joseph M. Hoefler, Perkiomenville, PA (US); Fu Zhan, Shanghai (CN); Caiyun Li, Shanghai (CN); Jiansheng Feng, Shanghai (CN); Qian Shen, Shanghai (CN)

(21) Appl. No.: 17/053,197

(22) PCT Filed: Jun. 6, 2018
(86) PCT No.: PCT/CN2018/090042

§ 371 Date: Nov. 5, 2020

(51) Int. Cl. C09D 175/04

(52) U.S. Cl. CPC C09D 175/04

(57) ABSTRACT

An aqueous coating composition suitable for automotive leather finishing topcoats that has low odor and low VOC content, and also exhibits acceptable pot life.

### FIELD OF THE INVENTION

The present invention relates to an aqueous coating composition and a process of preparing the same.

### INTRODUCTION

Greater emphasis on environmental awareness continues to be a strong consumer led market driver for the automotive leather industry which in turn has led to an increased demand for products with minimized odor and volatile organic compounds (VOCs).

Automotive leather upholstery is finished with topcoat compositions that typically comprise aqueous polymer binders, water-dispersible polyisocyanate crosslinkers, matting agents, and optionally pigment and hand-feel modifiers. One major source of odor and VOCs in topcoat compositions is polyisocyanate crosslinkers. Water-dispersible polyisocyanate crosslinkers are supplied, normally dissolved in organic solvents like Ethyl 3-Ethoxypropionante (EEP). Water-dispersible polyisocyanates dissolved in EEP can offer acceptable pot life when blended with aqueous polymer binders prior to application, for example, the resultant coating compositions remain useable for about 4 hours at room temperature (20-25° C.). However, EEP can cause a strong unpleasant odor and contribute to VOCs. One potential solution is to replace EEP with alternative solvents like propylene carbonate having less odor but still being classified as VOCs. Additionally, the use of propylene carbonate may result in shortened pot life.

There remains a need for an aqueous coating composition suitable for automotive leather finishing topcoats that has less odor and lower VOC content than EEP-containing coating compositions, and exhibits acceptable pot life.

### SUMMARY OF THE INVENTION

The present invention provides an aqueous coating composition suitable for making leather topcoats, which comprises an aqueous polymer dispersion, a water-dispersible polyisocyanate and a specific ether-ester compound. The aqueous coating composition of the present invention has less odor and lower VOC content than EEP-containing coating compositions. The aqueous coating composition also has acceptable pot life, as indicated by delta viscosity less than 10 seconds in accordance with the test method described in the Examples section below.

In a first aspect, the present invention is an aqueous coating composition comprising:

(a) from 20% to 80% by solids weight, based on the solids weight of the aqueous coating composition, of an aqueous polymer dispersion comprising a polymer having a Tg of less than 0° C.;

(b) from 5% to 50% by solids weight, based on solids weight of the aqueous coating composition, of a water-dispersible polyisocyanate;

(c) a solvent comprising, based on the total weight of the solvent, 30% by weight or more of an ether-ester compound having the structure of formula (I),

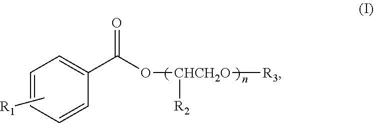

where R₁ represents hydrogen or a C₁-C₄ alkyl group, R₂ represents hydrogen or methyl, R₃ represents a C₁-C₄ alkyl group, and n is 1 or 2; and

wherein the solvent is present in an amount of from 45% to 300%, by weight based on the solids weight of the water-dispersible polyisocyanate; and

(d) from 2% to 30% by solids weight, based on the solids weight of the aqueous coating composition, of a matting agent.

In a second aspect, the present invention is a process of preparing the aqueous coating composition of the first aspect. The process comprises:

(i) providing a solution of a water-dispersible polyisocyanate in a solvent, wherein the solvent comprises, based on the total weight of the solvent, 30% by weight or more of an ether-ester compound having the structure of formula (I),

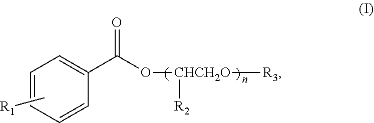

where R₁ represents hydrogen or a C₁-C₄ alkyl group, R₂ represents hydrogen or methyl, R₃ represents a C₁-C₄ alkyl group, and n is 1 or 2;

wherein the solvent is present in an amount of from 45% to 300%, by weight based on the solids weight of the water-dispersible polyisocyanate; and

(ii) mixing the water-dispersible polyisocyanate solution with an aqueous polymer dispersion comprising a polymer having a Tg of less than 0° C., and a matting agent to form the aqueous coating composition;

wherein the aqueous coating composition comprises, based on the solids weight of the aqueous coating composition, from 5% to 50% by solids weight of the water-dispersible polyisocyanate, from 20% to 80% by solids weight of the aqueous polymer dispersion, and from 2% to 30% by solids weight of the matting agent.

### DETAILED DESCRIPTION OF THE INVENTION

“Acrylic” in the present invention includes (meth)acrylic acid, (meth)alkyl acrylate, (meth)acrylamide, (meth)acrylonitrile and their modified forms such as (meth)hydroxyalkyl acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

As used herein, the term structural units, also known as polymerized units, of the named monomer refers to the remnant of the monomer after polymerization, or the monomer in polymerized form. For example, a structural unit of methyl methacrylate is as illustrated:

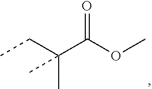

where the dotted lines represent the points of attachment of the structural unit to the polymer backbone.

“Aqueous” composition or dispersion herein means that particles dispersed in an aqueous medium. By “aqueous medium” herein is meant water and from 0 to 30%, by weight based on the weight of the medium, of water-miscible compound(s) such as, for example, alcohols, glycols, glycol ethers, glycol esters, and the like.

The aqueous coating composition of the present invention comprises one or more water-dispersible polyisocyanates useful as crosslinkers. The water-dispersible polyisocyanate may comprise a polyisocyanate and a modified polyisocyanate comprising at least one anionic group, at least one polyethylene oxide segment, or both an anionic group and a polyethylene oxide segment. As used herein, an anionic group is a chemical group that carries negative charge. The negative charge may be −1, −2, or −3. A compound with an anionic group is associated with one or more cations. The associated cation may be a metal cation or an organic compound with a cationic group, a group having a positive charge of +1, +2, or +3. Preferred anionic group is sulphonate, carboxylate, carboxylic acid group, phosphonate, or a mixture thereof. As used herein, a polyisocyanate herein refers to a polymer of an isocyanate compound, an adduct of an isocyanate compound, or a mixture thereof. The adduct herein refers to a product prepared by reacting at least one isocyanate compound with a compound having at least two hydrogen atoms which are reactive toward isocyanate groups. The adduct useful in the present invention can be an adduct of the isocyanate compound with one or more polyols including, for example, trimethylolpropane, propylene glycol, dipropylene glycol, and mixtures thereof.

The isocyanate compounds useful in the present invention may include aliphatic, cycloaliphatic, or aromatic isocyanate compounds, and mixtures thereof. Suitable aliphatic isocyanate compounds may include, for example, omega-alkylene diisocyanates having from 5 to 20 carbon atoms, such as hexamethylene-1,6-diisocyanate (HDI), 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, their isomers, and mixtures thereof. Examples of suitable cycloaliphatic isocyanate compounds include dicyclohexylmethane diisocyanate, isophorone diisocyanate, 1,4-cyclohexane diisocyanate, 1,3-bis-(isocyanatomethyl)cyclohexane, their isomers and mixtures thereof. Examples of suitable aromatic isocyanate compounds include m-tetramethyl xylylene diisocyanate, p-tetramethyl xylylene diisocyanate, 1,4-xylylene diisocyanate, 1,3-xylylene diisocyanate, 4,4′-diphenylmethylene diisocyanate, toluene diisocyanate; their isomers; and mixtures thereof.

The polyisocyanates useful in the present invention may have two or more isocyanate (NCO) groups on average, preferably two to four isocyanate groups per molecule. The polyisocyanates typically comprise from 5 to 60 carbon atoms, from 10 to 50 carbon atoms, or from 15 to 40 carbon atoms. The polyisocyanates are preferably aliphatic or cycloaliphatic polyisocyanates. More preferably, the polyisocyanates are hexamethylene diisocyanate homopolymers, hexamethylene diisocyanate adducts, isophorone diisocyanate homopolymers, isophorone diisocyanate adducts, or mixtures thereof.

Suitable commercially available water-dispersible polyisocyanates may include, for example, BAYHYDUR XP2655 hydrophilic aliphatic polyisocyanate based on hexamethylene diisocyanate available from Covestro. The water-dispersible polyisocyanate in the aqueous coating composition may be present, by solids weight (i.e., dry weight) based on the total solids weight of the aqueous coating composition, in an amount of 5% or more, 10% or more, 15% or more, 20% or more, 25% or more, or even 30% or more, and at the same time, 50% or less, 45% or less, 40% or less, or even 35% or less.

The aqueous coating composition of the present invention further comprises one or more solvents comprising one or more ether-ester compounds having the structure of formula (I),

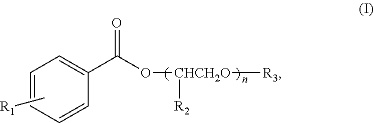

where R₁ represents hydrogen or a C₁-C₄ alkyl group (i.e., an alkyl group having from 1 to 4 carbon atoms), preferably hydrogen or methyl; R₂ represents hydrogen or methyl; R₃ represents a C₁-C₄ alkyl group; and n is 1 or 2. The ether-ester compound may have a boiling point of 250° C. or higher, 260° C. or higher, 270° C. or higher, 280° C. or higher, or even 290° C. or higher. Examples of suitable ether-ester compounds include 2-butoxyethyl benzoate, 2-propoxyethyl benzoate, 2-ethoxyethyl benzoate, 2-ethoxyethyl toluate, 2-propoxyethyl toluate, 2-butoxyethyl toluate, and mixtures thereof. In addition to the ether-ester compound, the solvent in the aqueous coating composition may further comprise one or more additional solvents that are different from the ether-ester compound. Examples of suitable additional solvents include propylene carbonate, propylene glycol diacetate, ethyl 3-ethoxy propionate, dipropylene glycol dimethyl ether, butyl cellosolve acetate, and mixtures thereof. The ether-ester compound may be present, by weight based on the total weight of the solvent, 30% or more, 35% or more, 40% or more, 45% or more, 50% or more, 55% or more, 60% or more, 65% or more, 70% or more, 75% or more, 80% or more, 85% or more, 90% or more, 95% or more, or even 100%. All solvents in the aqueous coating composition may be present, by weight based on the solids weight of the water-dispersible polyisocyanate, in a combined amount of 45% or more, 48% or more, 50% or more, 52% or more, 55% or more, 58% or more, 60% or more, or even 65% or more, and at the same time, 300% or less, 250% or less, 200% or less, 150% or less, 100% or less, 90% or less, 80% or less, or even 70% or less.

The aqueous coating composition of the present invention further comprises one or more aqueous polymer dispersions that include acrylic polymer dispersions, polyurethane dispersions, acrylic polymer/polyurethane hybrid dispersions, and mixtures thereof. The aqueous polymer dispersions can be used as binders.

The polyurethane dispersion useful in the present invention may be prepared by reacting one or more polyols with one or more isocyanate compounds. “Polyol” refers to any product having two or more hydroxyl groups per molecule. Polyols useful in preparing the polyurethane may include polyether diols, polyester diols, multi-functional polyols, and mixtures thereof. The polyols may be selected from the group consisting of polyether polyols, polyester polyols, and polycarbonate polyols. The polyether polyols useful for preparing the polyurethane may contain a —C—O—C— group. They can be obtained by reacting starting compounds that contain reactive hydrogen atoms such as water or diols, with alkylene oxides such as ethylene oxide, propylene oxide, butylene oxide, styrene oxide, tetrahydrofuran, epichlorohydrin, or mixtures thereof. Preferred polyether polyols include poly(propylene glycol) with a molecular weight of from 400 to 3,000, polytetrahydrofuran and copolymers of poly(ethylene glycol) and poly(propylene glycol). The diols useful in preparing the polyether polyols may include alkylene glycols, preferably ethylene glycol, diethylene glycol and butylene glycol, and mixtures thereof. The polyester polyols useful in preparing the polyurethane are typically esterification products prepared by the reaction of organic polycarboxylic acids or their anhydrides with a stoichiometric excess of a diol(s). Examples of suitable polyester polyols useful in preparing the polyurethane include poly(glycol adipate), poly(ethylene terephthalate) polyols, polycaprolactone polyols, alkyd polyols, orthophthalic polyols, sulfonated and phosphonated polyols, and mixtures thereof. The diols useful in preparing the polyester polyols include those described above for preparing the polyether polyols. Suitable carboxylic acids useful in preparing the polyester polyols may include dicarboxylic acids, tricarboxylic acids and anhydrides, such as maleic acid, maleic anhydride, succinic acid, glutaric acid, glutaric anhydride, adipic acid, suberic acid, pimelic acid, azelaic acid, sebacic acid, chlorendic acid, 1,2,4-butane-tricarboxylic acid, phthalic acid, the isomers of phthalic acid, phthalic anhydride, fumaric acid, dimeric fatty acids such as oleic acid, and the like, and mixtures thereof. Preferred polycarboxylic acids useful in preparing the polyester polyols include aliphatic and aromatic dibasic acids. The isocyanate compounds useful in preparing the polyurethane may include those described in the water-dispersible polyisocyanate section above. Specific examples include hexamethylene-1,6-diisocyanate, 1,12-dodecane diisocyanate, isophorone diisocyanate, and mixtures thereof.

The polyurethane useful in the present invention may have a number average molecular weight of 2,000 or more, 5,000 or more, 10,000 or more, 20,000 or more, 50,000 or more, or even 100,000 or more as measured by gel permeation chromatography (GPC) with polystyrene standard. The polyurethane dispersion may be prepared by techniques known in the art, for example, first preparing a polyurethane by reacting at least one polyol and at least one isocyanate compound described above, optionally in the presence of a catalyst, a solvent, and mixtures thereof; dispersing the obtained polyurethane in water typically in the presence of a surfactant; and optionally adding polyamines before, during and/or after dispersing the polyurethane in water. Suitable commercially available polyurethane dispersions may include, for example, PRIMAL™ Binder U-91 polyurethane dispersion available from The Dow Chemical Company (PRIMAL is a trademark of The Dow Chemical Company).

The acrylic polymer dispersion useful in the present invention comprises one or more acrylic polymers. The acrylic polymer may comprise structural units of one or more ethylenically unsaturated monomers having one or more functional groups. The functional groups may be a carboxyl, amide, sulfonate, acetoacetate, carbonyl, ureido, imide, amino, or phosphorous group, or combinations thereof. Examples of such functional-group-containing ethylenically unsaturated monomers include α, β-ethylenically unsaturated carboxylic acids including an acid-bearing monomer such as methacrylic acid, acrylic acid, itaconic acid, maleic acid, crotonic acid, acyloxypropionic acid, or fumaric acid; a monomer bearing an acid-forming group which yields or is subsequently convertible to, such an acid group (such as anhydride, (meth)acrylic anhydride, or maleic anhydride); acrylamide, methacrylamide, N-methylacrylamide, N-ethylacrylamide, N-isopropylacrylamide, N-butylacrylamide, N-tertiary butylacrylamide, N-2-ethylhexylacrylamide, N,N-dimethylacrylamide, N,N-diethylacrylamide and diacetoneacrylamide; sulfonate monomers such as sodium styrene sulfonate (SSS) and sodium vinyl sulfonate (SVS); acrylamido-2-methylpropanesulfonic acid (AMPS), salts thereof; phosphoalkyl (meth)acrylates such as phosphoethyl (meth)acrylate, phosphopropyl (meth)acrylate, phosphobutyl (meth)acrylate, salts thereof; diacetone acrylamide (DAAM), acetoacetoxyethyl (meth)acrylate, acetoacetoxypropyl (meth)acrylate, acetoacetoxybutyl (meth)acrylate, 2,3-di(acetoacetoxy) propyl (meth)acrylate, allyl acetoacetates, or vinyl acetoacetates; and mixtures thereof. Preferred functional-group-containing ethylenically unsaturated monomers are selected from the group consisting of acrylic acid, methyl acrylic acid, acrylamide and methylacrylamide. The acrylic polymer may comprise, by weight based on the weight of the acrylic polymer, zero or more, 0.1% or more, 0.3% or more, 0.5% or more, or even 1% or more, and at the same time, 20% or less, 15% or less, 10% or less, 8% or less, or even 5% or less, of structural units of the functional-group-containing ethylenically unsaturated monomer. Weight of the acrylic polymer in the present invention refers to dry weight or solids weight of the acrylic polymer.

The acrylic polymer useful in the present invention may also comprise structural units of one or more ethylenically unsaturated nonionic monomers that are different from the functional-group-containing ethylenically unsaturated monomer above. As used herein, the term “nonionic monomers” refers to monomers that do not bear an ionic charge between pH=1-14. Suitable ethylenically unsaturated nonionic monomers may include, for example, alkyl esters of (meth)acrylic acids, vinyl aromatic monomers such as styrene and substituted styrenes, vinyl esters of carboxylic acids, ethylenically unsaturated nitriles, or mixtures thereof. Preferably, the ethylenically unsaturated nonionic monomer includes a C₁-C₁₈, C₁-C₁₀, or C₁-C₆-alkyl ester of (meth)acrylic acid, for example, methyl acrylate, methyl methacrylate, ethyl acrylate, butyl (meth)acrylate, 2-ethylhexyl acrylate, hexyl (meth)acrylate, lauryl (meth)acrylate, stearyl (meth)acrylate, cyclohexyl (meth)acrylate, benzyl(meth)acrylate, oleyl(meth)acrylate, palmityl (meth)acrylate, nonyl(meth)acrylate, decyl (meth)acrylate, dodecyl (meth)acrylate, pentadecyl (meth) acrylate, hexadecyl (meth)acrylate, octadecyl (meth)acrylate, 2-hydroxyethyl acrylate, 2-hydroxyethyl methacrylate, 2-hydroxypropylacrylate, 2-hydroxypropyl methacrylate, 3-hydroxypropyl acrylate, and 3-hydroxypropyl methacrylate, and mixtures thereof. The acrylic polymer may comprise, by weight based on the weight of the acrylic polymer, from 80% to 100%, from 85% to 99.7%, from 90% to 99.5%, or from 95% to 99%, of structural units of the ethylenically unsaturated nonionic monomers.

The aqueous polymer dispersion useful in the present invention may be an acrylic polymer/polyurethane hybrid dispersion. The hybrid dispersion may be prepared by emulsion polymerization of the monomers described above useful in preparing the acrylic polymer in an aqueous medium in the presence of a polyurethane, for example, first providing the polyurethane, preferably the polyurethane dispersion, and then loading and polymerizing monomers used for making the acrylic polymer, thus to obtain the hybrid dispersion. The polyurethane in the acrylic polymer/polyurethane hybrid dispersion include those described in the polyurethane dispersion section above. The weight ratio of polyurethane to acrylic polymer in the acrylic polymer/polyurethane hybrid dispersion may be from 20/80 to 99/1, from 35/65 to 75/25, or from 40/60 to 60/40.

The acrylic polymer dispersion and/or the acrylic polymer/polyurethane hybrid dispersions may be prepared by free-radical polymerization, preferably emulsion polymerization. Temperature suitable for emulsion polymerization may be lower than 100° C., in the range of from 15 to 95° C., or in the range of from 30 to 90° C.

In the emulsion polymerization, free radical initiators may be used. The emulsion polymerization process may be thermally initiated or redox initiated emulsion polymerization. Examples of suitable free radical initiators include hydrogen peroxide, t-butyl hydroperoxide, cumene hydroperoxide, ammonium and/or alkali metal persulfates, sodium perborate, perphosphoric acid, and salts thereof; potassium permanganate, and ammonium or alkali metal salts of peroxydisulfuric acid. The free radical initiators may be used typically at a level of 0.01 to 3.0% by weight, based on the total weight of monomers. Redox systems comprising the above described initiators coupled with a suitable reductant may be used in the polymerization process. Examples of suitable reductants include sodium sulfoxylate formaldehyde, ascorbic acid, isoascorbic acid, alkali metal and ammonium salts of sulfur-containing acids, such as sodium sulfite, bisulfite, thiosulfate, hydrosulfite, sulfide, hydrosulfide or dithionite, formadinesulfinic acid, acetone bisulfite, glycolic acid, hydroxymethanesulfonic acid, glyoxylic acid hydrate, lactic acid, glyceric acid, malic acid, tartaric acid and salts of the preceding acids. Metal salts of iron, copper, manganese, silver, platinum, vanadium, nickel, chromium, palladium, or cobalt may be used to catalyze the redox reaction. Chelating agents for the metals may optionally be used.

In the emulsion polymerization, a surfactant may be used. The surfactant may be added prior to or during the polymerization of the monomers, or combinations thereof. A portion of the surfactant can also be added after the polymerization. These surfactants may include anionic and/or nonionic emulsifiers. Examples of suitable surfactants include alkali metal or ammonium salts of alkyl, aryl, or alkylaryl sulfates, sulfonates or phosphates; alkyl sulfonic acids; sulfosuccinate salts; fatty acids; polymerizable surfactants; and ethoxylated alcohols or phenols. The surfactant used is usually from 0.1% to 6% by weight or from 0.3% to 1.5% by weight, based on the weight of total monomers.

In the emulsion polymerization, a chain transfer agent may be used. Examples of suitable chain transfer agents include 3-mercaptopropionic acid, dodecyl mercaptan, methyl 3-mercaptopropionate, butyl 3-mercaptopropionate, benzenethiol, azelaic alkyl mercaptan, or mixtures thereof. The chain transfer agent may be used in an effective amount to control the molecular weight of the polymer, for example, from 0 to 2.5% by weight, from 0.03% to 1% by weight, or from 0.05% to 0.5% by weight, based on the total weight of monomers.

After completing the polymerization of the polymer, the obtained polymer dispersion may be neutralized by one or more bases as neutralizers to a pH value, for example, at least 6, from 6 to 10, or from 7 to 9. The bases may lead to partial or complete neutralization of the ionic or latently ionic groups of the polymer. Examples of suitable bases include ammonia; alkali metal or alkaline earth metal compounds such as sodium hydroxide, potassium hydroxide, calcium hydroxide, zinc oxide, magnesium oxide, sodium carbonate; primary, secondary, and tertiary amines, such as triethyl amine, ethylamine, propylamine, monoisopropylamine, monobutylamine, hexylamine, ethanolamine, diethyl amine, dimethyl amine, di-npropylamine, tributylamine, triethanolamine, dimethoxyethylamine, 2-ethoxyethylamine, 3-ethoxypropylamine, dimethylethanolamine, diisopropanolamine, morpholine, ethylenediamine, 2-diethylaminoethylamine, 2,3-diaminopropane, 1,2-propylenediamine, neopentanediamine, dimethylaminopropylamine, hexamethylenediamine, 4,9-dioxadodecane-1,12-diamine, polyethyleneimine or polyvinylamine; aluminum hydroxide; and mixtures thereof.

The polymer in the aqueous polymer dispersion may have a glass transition temperature (Tg) less than 0° C., for example, from −100° C. to 0° C., from −70° C. to −5° C., from −65° C. to −10° C., from −60° C. to −15° C., or from −60° C. to −20° C. The particular Tg values reported herein are those measured by differential scanning calorimetry (DSC) according to ASTM D3418-12 (2012) Standard Test Method for Transition Temperatures and Enthalpies of Fusion and Crystallization of Polymers by Differential Scanning calorimetry. A 5-10 milligram (mg) sample can be analyzed in an open aluminum pan on a TA Instrument DSC Q2000 fitted with an auto-sampler under nitrogen atmosphere. Tg measurement by DSC is with from −90° C. to 150° C., 20° C./min; 2 cycles. The Tg was measured at the midpoint of the inflection obtained in the 2^{nd} cycle using the half height method.

Polymer particles in the aqueous polymer dispersion may have a number average particle size of from 30 nanometers (nm) or more, 40 nm or more, 50 nm or more, or even 60 nm or more, and at the same time, 500 nm or less, 300 nm or less, 200 nm or less, 150 nm or less, or even 120 nm or less, as measured by Brookhaven BI-90 Particle Size Analyzer.

The aqueous coating composition of the present invention may comprise, by solids weight based on the solids weight of the aqueous coating composition, 20% or more, 25% or more, 30% or more, or even 35% or more, and at the same time, 80% or less, 70% or less, 60% or less, 50% or less, or even 40%, of the aqueous polymer dispersion.

The aqueous coating composition of the present invention may further comprise one or more matting agents. “Matting agents” herein refer to any inorganic or organic particles that provide matt effect. Matting agents usually have an average particle size of 3.5 microns or more, according to ASTM E2651-10 (2010) Standard Guide for Powder Particle Size Analysis. Suitable matting agents useful in the present invention may include silica matting agents, polyurea matting agents, polyacrylate matting agents, polyethylene matting agents, polytetrafluoroethene matting agents, and mixtures thereof. Preferred matting agent are silica matting agents, polyacrylate matting agents, polyurea matting agents, and mixtures thereof. Suitable commercially available matting agents include, for example, ACEMATT TS-100 and OK520 silica matting agents both available from Evonik, DEUTERON MK polyurea matting agent available from Deuteron, SYLOID Silica 7000 matting agent available from Grace Davison, PARALOID™ PRD 137B emulsion based on polyacrylate available from The Dow Chemical Company (PARALOID is a trademark of The Dow Chemical Company); ULTRALUBE D277 emulsion based on HDPE/plastic, ULTRALUBE D818 emulsion based on montan/PE/plastic, and ULTRALUBE D860 emulsion based on PE/ester matting agents all available from Keim-Additec; and mixtures thereof. The matting agent may be present, by solids weight based on the solids weight of the aqueous coating composition, in an amount of from 2% or more, 3% or more, 4% or more, or even 5% or more, and at the same time, 30% or less, 25% or less, 20% or less, 15% or less, or even 10% or less.

The aqueous coating composition of the present invention may further comprise one or more thickeners, also known as “rheology modifiers”. Examples of suitable thickeners include alkali swellable emulsions (ASE); hydrophobically modified alkali swellable emulsions (HASE); associative thickeners such as hydrophobically modified ethoxylated urethanes (HEUR); and cellulosic thickeners such as methyl cellulose ethers, hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, and 2-hydoxypropyl cellulose. Preferred thickener is HEUR, HASE or ASE. The thickener may be present, by solids weight based on the total solids weight of the aqueous coating composition, in an amount of from 0 to 7%, from 0.2% to 6%, from 0.5% to 5%, or from 0.8% to 4%.

The aqueous coating composition of the present invention may also comprise one or more leveling agents. “Leveling agents” refers to chemical substances which enable the coating composition to more uniformly wet substrate and decrease surface defects. Examples of suitable leveling agents include polydimethylsiloxane, modified polydimethylsiloxane, polyacrylate, fluorocarbon surfactant, and mixtures thereof. The leveling agent may be present, by weight based on the total solids weight of the coating composition, from 0 to 15%, from 0 to 10%, from 0.3% to 7%, from 0.5% to 6%, or from 0.7% to 5%.

The aqueous coating composition of the present invention may also comprise one or more hand feel modifiers. “Hand feel modifiers” refers to chemicals which are added into coating formulations with the purpose to endow dried films made therefrom with pleasant hand feeling. Examples of suitable hand feel modifiers include silicones, wax emulsions, polyacrylic polymer and mixtures thereof. The hand feel modifier may be present, by solids weight based on the total solids weight of the coating composition, from 0 to 40%, from 2% to 30%, from 4% to 25%, or from 6% to 20%.

The aqueous coating composition of the present invention may further comprise pigments and/or extenders. “Pigment” herein refers to a particulate inorganic material which is capable of materially contributing to the opacity or hiding capability of a coating. Such materials typically have a refractive index greater than 1.8. Inorganic pigments may include, for example, titanium dioxide (TiO₂), zinc oxide, iron oxide, zinc sulfide, barium sulfate, barium carbonate, or mixture thereof. In a preferred embodiment, pigment used in the present invention is TiO₂. TiO₂ typically exists in two crystal forms, anatase and rutile. TiO₂ may be also available in concentrated dispersion form. The aqueous coating composition may also comprise one or more extenders. “Extender” herein refers to a particulate material having a refractive index of less than or equal to 1.8 and greater than 1.3. Examples of suitable extenders include calcium carbonate, clay, calcium sulfate, aluminosilicates, silicates, zeolites, mica, diatomaceous earth, solid or hollow glass, ceramic beads, nepheline syenite, feldspar, diatomaceous earth, calcined diatomaceous earth, talc (hydrated magnesium silicate), silica, alumina, kaolin, pyrophyllite, perlite, baryte, wollastonite, opaque polymers such as ROPAQUE™ Ultra E available from The Dow Chemical Company (ROPAQUE is a trademark of The Dow Chemical Company), or mixtures thereof. The pigments and/or extenders may be present, based on the total solids weight of the coating composition, in a combined amount of from 0 to 30% by weight, from 2% to 25% by weight, or from 4% to 20% by weight.

The solids content of the aqueous coating composition may be in the range of from 10% to 60%, from 15% to 50%, or from 25% to 45%, by weight based on the weight of the coating composition.

In addition to the components described above, the aqueous coating composition of the present invention may further comprise any one or combination of the following additives: buffers, neutralizers, freeze/thaw additives, humectants, mildewcides, biocides, anti-skinning agents, colorants, flowing agents, anti-oxidants, plasticizers, thixotropic agents, adhesion promoters, and grind vehicles. These additives may be present in a combined amount of from 0 to 10%, from 0.3% to 5%, or from 0.5% to 3%, by solids weight based on the solids weight of the aqueous coating composition.

The aqueous coating composition of the present invention may be prepared by providing a solution of the water-dispersible polyisocyanate in the solvent, which can be prepared by dissolving the water-dispersible polyisocyanate in the solvent; mixing the resultant water-dispersible polyisocyanate solution, the aqueous polymer dispersion, and the matting agent to form the aqueous coating composition. Components in the aqueous coating composition may be mixed in any order to provide the aqueous coating composition of the present invention. Any of the above-mentioned optional components may also be added to the composition during or prior to the mixing to form the aqueous coating composition.

The aqueous coating composition of the present invention have lower VOC content and less odor as compared to EEP-containing coating compositions. The aqueous coating composition may have 100 grams (g) or less of VOCs per liter (L) of the aqueous coating compositions, 50 g/L or less, 30 g/L or less, or even 10 g/L or less, as measured by GB 18582-2008 Standard for indoor decorating and refurbishing materials-limit of harmful substances of interior architectural coatings (P. R. China). The aqueous coating composition also has acceptable pot life that is comparable to EEP-containing coating compositions, for example, as indicated by delta viscosity less than 10 seconds, less than 9 seconds, or even less than 8 seconds, as measured according to the test method described in the Examples section below. The aqueous coating composition can also provide comparable properties including, for example, bally flexibility, wet rub fastness, and/or Gakushin rub fastness as compared to propylene glycol diacetate (PGDA)-containing coating compositions, according to the test methods described in the Examples section below.

The present invention also relates to a process of using the aqueous coating composition, comprising forming the aqueous coating composition, applying the aqueous coating composition to a substrate, and drying, optionally curing the applied coating composition. The present invention also relates to a method of preparing a coating, comprising forming the aqueous coating composition of the present invention, applying the aqueous coating composition to a substrate, and drying, or allowing to dry the applied aqueous coating composition to form the coating. Drying may be performed in a known manner such as, for example, air drying or heat drying at temperatures that will not damage the substrate, for example, 150° C. or below, or 120° C. or below, for example, from 50 to 100° C.

The aqueous coating composition of the present invention may be applied to architectural substrates or industrial substrates including, for example, flexible substrates including leather (e.g., natural leather, artificial leather, synthetic leather, and vinyl leather) such as leather upholstery, for example, automotive upholstery, metals, plastics, foams, stones, elastomeric substrates, fabrics, concrete, or cementitious substrates by any known method, such as, for example, brushing, dipping, rolling and spraying. The coating composition is particularly suitable for automotive leather finishing. The aqueous coating composition may be applied to unfinished or basecoat finished leather such as, for example, mineral tanned or vegetable tanned leather including full-grain leather, buffed or corrected-grain leather, and split leather; or to paper; by curtain coater and spraying methods such as, for example, air-atomized spray, air assisted spray, airless spray, high volume low pressure spray, and air-assisted airless spray, by roll coating or knife coating. The aqueous coating composition can be applied directly onto leather or indirectly coated over a primer layer. The primer can be a conventional primer comprising a (meth)acrylic polymer, a polyurethane, a polyacrylonitrile, a polybutadiene, a polystyrene, a polyvinyl chloride, a polyvinylidene chloride, a polyvinyl acetate, and combinations thereof.

### EXAMPLES

Some embodiments of the invention will now be described in the following Examples, wherein all parts and percentages are by weight unless otherwise specified. The following materials are used in the examples:

Ethyl 3-ethoxypropionate (EEP), 1,2-propanediol, diacetate (PGDA), and 2-butoxyethyl benzoate (BCB) are all available from The Dow Chemical Company.

Propylene carbonate (PC) is available from Lixing Chemical.

AQUADERM Fluid H (100% solids), available from Lanxess, is a polyester modified polysiloxane leveling agent.

OPTI-MATT™ UD-4 polyurethane based duller (25% solids), available from The Dow Chemical Company, comprises a polyurethane dispersion (Tg: about −54±2° C.) as a binder and a mixture of inorganic silica and organic acrylic beads as matting agents.

EUDERM Black BN pigment dispersion (23% solids), available from Lanxess, comprises carbon and an acrylic binder.

HYDRHOLAC™ CL-20 Emulsion (36% solids), available from The Dow Chemical Company, is an acrylic polymer dispersion (Tg: about −52±2° C.) as a binder.

ROSILK™ 2229 Hand feel modifier (60% solids), available from The Dow Chemical Company, is an aqueous silicone emulsion (ROSILK is a trademark of The Dow Chemical Company).

ACRYSOL™ RM-819W thickener (18% solids), available from The Dow Chemical Company, is a hydrophobically modified ethoxylated urethane.

A water-dispersible polyisocyanate (100% solids), available from Covestro, comprises homopolymer of hexamethylene diisocyanate, and blocked hexane, 1, 6-diisocyanato-, homopolymer.

OPTI-MATT, HYDRHOLAC and ACRYSOL are trademarks of The Dow Chemical Company.

The following standard analytical equipment and methods are used in the Examples.

Pot Life

A water-dispersible polyisocyanate (100% solids) was dissolved in different solvents to form crosslinker solutions with different solids content. Then each crosslinker solution was mixed with other components in a coating composition except ACRYSOL RM-819 thickener to form a mixture.

Then, ACRYSOL RM-819 thickener was added as a thickener to the mixture in an amount to adjust the viscosity of the resultant coating composition to ideally 20-21 seconds. The viscosity was measured by using a Zahn 2# viscosity cup with second as the unit. Twenty minutes and 210 minutes after the formation of the coating composition, viscosities were recorded as initial and final viscosities, respectively. The delta viscosity between the initial viscosity and the final viscosity was used to evaluate the pot life. The maximum acceptable delta viscosity is 10 seconds. Otherwise, if the coating composition gels or delta viscosity larger than 10 seconds, the coating composition has poor pot life. Higher viscosity change represents for shorter pot life.

Odor Evaluation

Odor evaluation was performed according to olfaction sensation. For each sample, eight odor panelists were given “blind” samples of each solvent sample and then smell the sample. The panelists rated each sample on a scale of 1 to 3, where 1 stands for strong odor, 2 stands for medium odor, and 3 stands for low odor. The odor rating is determined by averaging the scores given by all the panelists. The odor rating of 2.0 or above is acceptable or stands for low odor. Higher rating represents for lower odor.

Gloss

Gloss(60°) was measured on leather surface using a gloss meter (BYK Gardner USA MICRO-TRI-GLOSS meter, catalogue number 4520). The maximum acceptable gloss(60°) is 1.5.

Bally Flexibility

Bally flexibility was measured in accordance with ASTM D6182-00 (2010) (Standard Test Method for Flexibility and Adhesion of Finished Leather) by repeatedly flexing a leather specimen over the cited number of cycles and temperature, specifically, 100,000 cycles at 20° C. and 30,000 cycles at −10° C., respectively. After flexing, the leather was evaluated using a stereoscope (at 10× magnification) to assess damage to the finish. The finish showing no cracking or white crazing is rated as “Pass”. Otherwise, cracking or white crazing is rated as “Fail”.

Wet Rub Fastness Test

Wet rub fastness was determined in accordance with ASTM D 5053-03 (2009) (Standard Test Method for Color fastness of Crocking Leather). The wet rub fastness test was conducted using a rub fastness (Satra Footware Technology Center model STM421). A 11.5 cm×3.5 cm Swatch was removed from the finished crust. To determine the finish fastness of the top-coated leather, a 1.5 cm×1.5 cm felt rubbing pad was saturated with water and placed on the equipment rubbing head (total weight of rubbing head was 1 kilogram). To complete the testing, the leather Swatch was inserted into the rub fastness tester and stretched an additional 10%, the water saturated felt pad was applied to the finished surface, and 1,000 rubbing cycles and 2,000 rubbing cycles were completed, respectively. The finish was visually evaluated for damage and the felt pad used for the test was visually evaluated for pigment transfer by comparing it to a control felt pad (un-used felt pad). The color difference between the felt pads was assessed using a grayscale chart.

Gakushin Test Method

The Gakushin test was conducted as follows: an abrasive cloth, #6 duct cloth, was fixed to a platen and a strip of leather was fixed to a head. The cloth and the leather were contacted together and a total head weight above the leather of 1 kilogram (kg) was set in place. The test was activated and the platen moved back and forth at a rate of 30 cycles per minute enabling the duct cloth to rub across the surface of the leather swatch with the pressure of 1 kg applied. The test is complete when the leather coating is abraded to the extent that the russet becomes visible or 20,000 cycles, whichever occurs first. The number of test cycles was recorded, where 8,000 cycles or more is rated as “Pass”, and less than 8,000 cycles is rated as “Fail”.

Coating Compositions

Coating compositions were prepared based on formulations given in Table 1. The water-dispersible polyisocyanate and solvents were mixed together and stirred for a few minutes to form a transparent crosslinker solution first. Other materials listed in Table 1, except ACRYSOL RM-819 thickener and the crosslinker solution, were added into a container in order with agitation (200 revolutions per minute (rpm)). The crosslinker solution was then added to the container with agitation (200 rpm) to form a mixture. ACRYSOL RM-819 thickener was then added to the mixture to adjust the viscosity, ideally targeting 20-21 seconds as measured by using a Zahn 2# viscosity cup, thus forming the coating compositions. These coating compositions were evaluated according to the test methods described above and properties are given in Tables 1 and 2.

As shown in Table 1, the coating compositions that didn't comprise BCB (Comp Exs A and B), or only contained 25% by weight of BCB (Comp Ex C), based on the weight of total solvents, all demonstrated poor pot life as indicated by showing gel or delta viscosity higher than 10 seconds. The coating compositions of Comp Exs D and E comprising solutions of water-dispersible polyisocyanate in BCB with solids content of 70% and 75%, respectively, both showed undesirably short pot life. In contrast, the coating compositions of Exs 1-4 all surprisingly exhibited much longer pot life as indicated by delta viscosity less than 10 seconds.

In addition, the results of odor evaluation showed that the odor ratings for EEP, BCB, PGDA, and PC was 1.5, 2.9, 1.9 and 2.5, respectively. The boiling points of EEP, PGDA, PC, and BCB are 170° C., 191° C., 240° C., and 292° C., respectively. It indicates that the addition of BCB into coating compositions resulted in less odor and lower VOC content than the addition of EEP, PGDA or PC.

TABLE 1
Formulations and Properties of Leather Topcoats

| Raw materials, | Comp | | Comp | Comp | | | | Comp | Comp |
|---|---|---|---|---|---|---|---|---|---|
| gram | Ex A | Ex 1 | Ex B | Ex C | Ex 2 | Ex 3 | Ex 4 | Ex D | Ex E |
| Water | 60 | 60 | 108.5 | 108 | 108 | 107.5 | 121 | 132 | 142 |
| AQUADERM | 10 | 10 | 10 | 10 | 10 | 10 | 10 | 10 | 10 |
| Fluid H | | | | | | | | | |
| EUDERM | 30 | 30 | 10 | 10 | 10 | 10 | 10 | 10 | 10 |
| Black BN | | | | | | | | | |
| OPTI-MATT | 430 | 430 | 430 | 430 | 430 | 430 | 430 | 430 | 430 |
| UD-4 | | | | | | | | | |
| HYDRHOLAC | 200 | 200 | 200 | 200 | 200 | 200 | 200 | 200 | 200 |
| CL-20 | | | | | | | | | |
| ROSILK 2229 | 70 | 70 | 70 | 70 | 70 | 70 | 70 | 70 | 70 |
| RM-819W | 10 | 10 | 3 | 3.5 | 2.5 | 2.5 | 2.0 | 2.5 | 3.0 |
| Water-dispersible | 102 | 102 | 102 | 102 | 102 | 102 | 102 | 102 | 102 |
| polyisocyanate | | | | | | | | | |
| PGDA | 98 | | | | | | | | |
| PC | | | 68 | 51 | 34 | 17 | | | |
| BCB | | 98 | | 17 | 34 | 51 | 54.9 | 43.7 | 34 |
| Total | 1010 | 1010 | 1001.5 | 1001.5 | 1000.5 | 1000 | 999.9 | 1000.2 | 1001 |
| Pot life, second | 20.3 | 8.7 | gelled | 19.4 | 7.9 | 9.0 | 8.5 | 11.7 | 17.9 |

The aqueous coating composition of Ex 2 was further evaluated according to the test methods described above. As shown in Table 2, the aqueous coating composition of Ex 2 also provided acceptable properties for leather applications.

TABLE 2
Performance evaluation results

| | Comp Ex A | Ex 2 |
|---|---|---|
| Gloss (60°) | 1.0 | 1.0 |
| Flex at 20° C. | One sample | Two samples |
| for 100,000 cycles | borderline pass/one | borderline pass |
| (two samples run parallel | sample fail | |
| and perpendicular) | | |
| Flex at −10° C. | One sample | Two samples |
| for 30,000 cycles | pass/one | pass |
| (two samples run parallel | sample fail | |
| and perpendicular) | | |
| Wet Rub fastness | Pass | Pass |
| (1,000 cycles/1 kg) | | |
| Wet Rub fastness | Pass | Borderline Pass |
| (2,000 cycles/1 kg) | | (trace color, |
| | | no damage) |
| Gakushin | 15,800; 20,000 | 11,300; 13,200 |
| (cycles, run in duplicate) | (stopped at 20,000 | |
| | cycles) | |

What is claimed is:

1. An aqueous coating composition comprising:
(a) from 20% to 80% by solids weight, based on the solids weight of the aqueous coating composition, of an aqueous polymer dispersion comprising a polymer having a Tg of less than 0° C.;
(b) from 5% to 50% by solids weight, based on solids weight of the aqueous coating composition, of a water-dispersible polyisocyanate;
(c) a solvent comprising, based on the total weight of the solvent, 30% by weight or more of an ether-ester compound having the structure of formula (I), 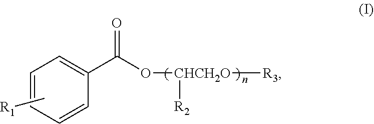
where R₁ represents hydrogen or a C₁-C₄ alkyl group, R₂ represents hydrogen or methyl, R₃ represents a C₁-C₄ alkyl group, and n is 1 or 2; and
wherein the solvent is present in an amount of from 45% to 300%, by weight based on the solids weight of the water-dispersible polyisocyanate; and
(d) from 2% to 30% by solids weight, based on the solids weight of the aqueous coating composition, of a matting agent.

2. The aqueous coating composition of claim 1, wherein the aqueous polymer dispersion is an acrylic polymer dispersion, a polyurethane dispersion, an acrylic polymer/polyurethane hybrid dispersion, or a mixture thereof.

3. The aqueous coating composition of claim 1, wherein the ether-ester compound is selected from the group consisting of 2-butoxyethyl benzoate, 2-propoxyethyl benzoate, 2-ethoxyethyl benzoate, 2-ethoxyethyl toluate, 2-propoxyethyl toluate, and 2-butoxyethyl toluate.

4. The aqueous coating composition of claim 1, wherein the water-dispersible polyisocyanate is dissolved in the solvent to form a solution, prior to mixing with the aqueous polymer dispersion and the matting agent.

5. The aqueous coating composition of claim 1, wherein the solvent is present in an amount of from 50% to 150% by weight, based on the solids weight of the water-dispersible polyisocyanate.

6. The aqueous coating composition of claim 1, wherein the solvent comprises, based on the total weight of the solvent, from 40% to 100% by weight of the ether-ester compound.

7. The aqueous coating composition of claim 1, wherein the water-dispersible polyisocyanate comprises homopolymers of hexamethylene diisocyanate.

8. The aqueous coating composition of claim 1, comprising from 15% to 35% by solids weight, based on solids weight of the aqueous coating composition, of the water-dispersible polyisocyanate.

9. The aqueous coating composition of claim 1, further comprising a leveling agent, a hand feel modifier, a thickener, a pigment, or mixtures thereof.

10. A process of preparing an aqueous coating composition, comprising:
(i) providing a solution of a water-dispersible polyisocyanate in a solvent, wherein the solvent comprises, based on the total weight of the solvent, 30% by weight or more of an ether-ester compound having the structure of formula (I), 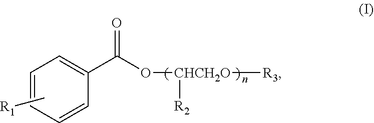
where R₁ represents hydrogen or a C₁-C₄ alkyl group, R₂ represents hydrogen or methyl, R₃ represents a C₁-C₄ alkyl group, and n is 1 or 2;
wherein the solvent is present in an amount of from 45% to 300%, by weight based on the solids weight of the water-dispersible polyisocyanate; and
(ii) mixing the water-dispersible polyisocyanate solution with an aqueous polymer dispersion comprising a polymer having a Tg of less than 0° C., and a matting agent to form the aqueous coating composition;
wherein the aqueous coating composition comprises, based on the solids weight of the aqueous coating composition, from 5% to 50% by solids weight of the water-dispersible polyisocyanate, from 20% to 80% by solids weight of the aqueous polymer dispersion, and from 2% to 30% by solids weight of the matting agent.
